(19) United States
(12) Patent Application Publication
(10) Pub. No.: US 2023/0388804 A1
(43) Pub. Date: Nov. 30, 2023

(54) SYSTEM AND METHOD FOR PREVENTING GEO-LOCATION DATA TAMPERING

(71) Applicant: BANK OF AMERICA CORPORATION, Charlotte, NC (US)

(72) Inventor: Shailendra Singh, Maharashtra (IN)

(73) Assignee: BANK OF AMERICA CORPORATION, Charlotte, NC (US)

(21) Appl. No.: 17/825,177

(22) Filed: May 26, 2022

(51) Int. Cl. H04W 12/64; H04W 12/122; H04W 4/021; H04L 9/00

(52) U.S. Cl. CPC H04W 12/64; H04W 12/122; H04W 4/021; H04L 9/50

(57) ABSTRACT

Various systems, methods, and computer program products for preventing geo-location data tampering. A method of preventing geo-location data tampering is provided. The method includes receiving location information relating to a location that is to be used for geo-fencing. The method also includes identifying one or more coordinates relating to the location based on the location information. The method further includes creating a tamperproof geographic resource based on the coordinates of the location. The tamperproof geographic resource is stored as a non-fungible token. The method still further includes determining one or more user features based on the tamperproof geographic resource and a computing device location of a computing device. The one or more user features determine the capabilities of the computing device.

### TECHNOLOGICAL FIELD

An example embodiment relates generally to data authentication and more particularly, to preventing geo-location data tampering.

### BACKGROUND

Geo-location data is widely used to control feature capabilities based on the location of a device. However, there are security issues that are present in current geo-fencing technology that can allow malfeasant actors to alter geo-fencing data and receive access to features that the malfeasant actor would otherwise not be capable of receiving. Therefore, there exists a need for a system that can prevent geo-location data tampering.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for preventing geo-location data tampering is provided. The system includes at least one non-transitory storage device and at least one processing device coupled to the at least one non-transitory storage device. The at least one processing device is configured to receive location information relating to a location that is to be used for geo-fencing. The at least one processing device is also configured to identify one or more coordinates relating to the location based on the location information. The at least one processing device is further configured to create a tamperproof geographic resource based on the coordinates of the location. The tamperproof geographic resource is stored as a non-fungible token. The at least one processing device is still further configured to determine one or more user features based on the tamperproof geographic resource and a computing device location of a computing device. The one or more user features determine the capabilities of the computing device.

In an example embodiment, the tamperproof geographic resource includes one or more instrument indicators and the one or more instrument indicators include information relating to the instrument that transmitted the one or more coordinates relating to the location. In some embodiments, the location information includes the one or more coordinates relating to the location, wherein the location information is received from a computing device associated with a user.

In some embodiments, the location information includes non-coordinate information that relates to the location. The at least one processing device is further configured to automatically identify the coordinates relating to the location based on the location information. In some embodiments, the tamperproof geographic resource comprises information relating to an author of the tamperproof geographic resource.

In some embodiments, the at least one processing device is further configured to detect a malfeasant action relating to a tamperproof geographic resource and cause a transmission of a notification to one or more users relating to the malfeasant action. In some embodiments, the at least one processing device is further configured to link the tamperproof geographic resource to a smart contract. In such an embodiment, the smart contract includes one or more location rules relating to the location.

In another example embodiment, a computer program product for preventing geo-location data tampering is provided. The computer program product includes at least one non-transitory computer-readable medium having computer-readable program code portions embodied therein. The computer-readable program code portions include an executable portion configured to receive location information relating to a location that is to be used for geo-fencing. The computer-readable program code portions also include an executable portion configured to identify one or more coordinates relating to the location based on the location information. The computer-readable program code portions further include an executable portion configured to create a tamperproof geographic resource based on the coordinates of the location. The tamperproof geographic resource is stored as a non-fungible token. The computer-readable program code portions still further include an executable portion configured to determine one or more user features based on the tamperproof geographic resource and a computing device location of a computing device. The one or more user features determine the capabilities of the computing device.

In some embodiments, the tamperproof geographic resource includes one or more instrument indicators and the one or more instrument indicators include information relating to the instrument that transmitted the one or more coordinates relating to the location. In some embodiments, the location information includes the one or more coordinates relating to the location and the location information is received from a computing device associated with a user.

In some embodiments, the location information includes non-coordinate information that relates to the location. In such an embodiment, the computer program product further includes an executable portion configured to automatically identify the coordinates relating to the location based on the location information.

In some embodiments, the tamperproof geographic resource includes information relating to an author of the tamperproof geographic resource. In some embodiments, the computer program product further includes an executable portion configured to detect a malfeasant action relating to a tamperproof geographic resource and cause a transmission of a notification to one or more users relating to the malfeasant action.

In some embodiments, the computer program product further includes an executable portion configured to link the tamperproof geographic resource to a smart contract, wherein the smart contract includes one or more location rules relating to the location.

In still another example embodiment, a computer-implemented method for preventing geo-location data tampering is provided. The method includes receiving location information relating to a location that is to be used for geo-fencing. The method also includes identifying one or more coordinates relating to the location based on the location information. The method further includes creating a tamperproof geographic resource based on the coordinates of the location. The tamperproof geographic resource is stored as a non-fungible token. The method still further includes determining one or more user features based on the tamperproof geographic resource and a computing device location of a computing device. The one or more user features determine the capabilities of the computing device.

In some embodiments, the tamperproof geographic resource includes one or more instrument indicators and the one or more instrument indicators include information relating to the instrument that transmitted the one or more coordinates relating to the location. In some embodiments, the location information includes the one or more coordinates relating to the location and the location information is received from a computing device associated with a user.

In some embodiments, the location information includes non-coordinate information that relates to the location. In such an embodiment, the method further includes automatically identifying the coordinates relating to the location based on the location information. In some embodiments, the method also includes detecting a malfeasant action relating to a tamperproof geographic resource and cause a transmission of a notification to one or more users relating to the malfeasant action. In some embodiments, the method also includes linking the tamperproof geographic resource to a smart contract, wherein the smart contract includes one or more location rules relating to the location.

Embodiments of the present disclosure address the above needs and/or achieve other advantages by providing apparatuses (e.g., a system, computer program product and/or other devices) and methods for preventing geo-location data tampering. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for preventing geo-location data tampering, in accordance with embodiments of the present disclosure;

FIG. 2 provides a block diagram illustrating the entity system 200 of FIG. 1, in accordance with embodiments of the present disclosure;

FIG. 3 provides a block diagram illustrating a geo-location data authentication engine device 300 of FIG. 1, in accordance with embodiments of the present disclosure;

FIG. 4 provides a block diagram illustrating the computing device system 400 of FIG. 1, in accordance with embodiments of the present disclosure;

FIG. 5 illustrates an example geo-fencing platform for performing the method of preventing geo-location data tampering in accordance with an embodiment of the present disclosure;

FIG. 6 illustrates an example geographic location that is being geo-fenced in accordance with an embodiment of the present disclosure;

FIG. 7 provides a flowchart illustrating a method of preventing geo-location data tampering in accordance with an embodiment of the present disclosure;

FIG. 8A illustrates an exemplary process of creating an NFT 800 in accordance with an embodiment of the present disclosure;

FIG. 8B illustrates an exemplary NFT 804 as a multi-layered documentation of a resource in accordance with an embodiment of the present disclosure; and

FIG. 9 illustrates another example use case of geo-fencing that may use various embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making prediction about a dataset. Machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

As used herein, “geofencing” is the act of creating a virtual boundary around a geographic area. The geo-fence boundary can be control and/or monitored using GPS, RFID, Wi-Fi, and/or cellular data. The geo-fence boundary can be paired with a software using GPS, RFID, Wi-Fi, and/or cellular data.

Various embodiments of the present disclosure allow for preventing geo-location data tampering. Upon receiving an initial geo-location data, the geo-location data is converted to a non-fungible token (“NFT”) and stored using smart contract rules. The NFT can be associated with a given computing device of a user. The NFT may have metadata that relates to said computing device. The geo-fencing coordinates may be user defined or automatically defined by the system. An example use of the method discussed herein include preventing geo-location data tampering by indicating one or more payment devices as a suspicious device. Various embodiments of the present disclosure allow for geo-location tampering to be prevented.

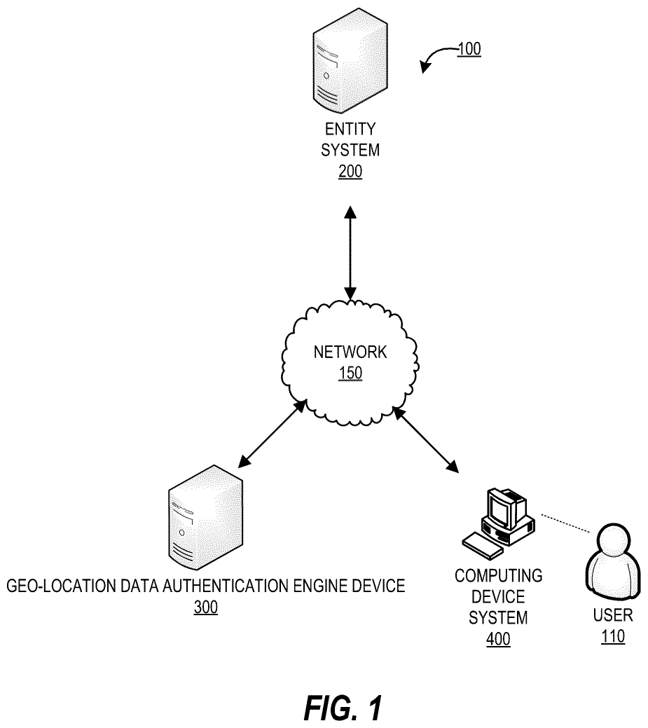

FIG. 1 provides a block diagram illustrating a system environment 100 for preventing geo-location data tampering. As illustrated in FIG. 1, the system environment 100 includes a geo-location data authentication engine device 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities.

The geo-location data authentication engine device 300 is a system of the present disclosure for performing one or more process steps described herein. In some embodiments, the geo-location data authentication engine device 300 may be an independent system. In some embodiments, the geo-location data authentication engine device 300 may be a part of the entity system 200. For example, the methods discussed herein may be carried out by the entity system 200, the geo-location data authentication engine device 300, the computing device system 400, and/or a combination thereof.

The geo-location data authentication engine device 300, the entity system 200, and/or the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the geo-location data authentication engine device 300 is configured to communicate information or instructions with the entity system 200, and/or the computing device system 400across the network 150. While the entity system 200, the geo-location data authentication engine device 300, the computing device system 400, and server device(s) are illustrated as separate components communicating via network 150, one or more of the components discussed here may be carried out via the same system (e.g., a single system may include the entity system 200 and the geo-location data authentication engine device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the geo-location data authentication engine device 300, and/or entity system 200 across the network 150.

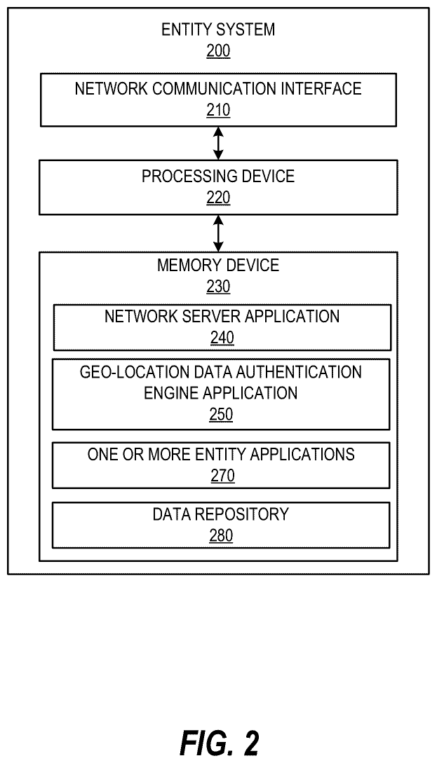

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a geo-location data authentication engine application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the geo-location data authentication engine application 250, the one or more entity application 270 to perform certain logic, data-extraction, and data-storing functions of the entity system 200 described herein, as well as communication functions of the entity system 200.

The network server application 240, the geo-location data authentication engine application 250, and the one or more entity applications 270 are configured to store data in the data repository 280 or to use the data stored in the data repository 280 when communicating through the network communication interface 210 with the geo-location data authentication engine device 300, and/or the computing device system 400 to perform one or more process steps described herein. In some embodiments, the entity system 200 may receive instructions from the geo-location data authentication engine device 300 via the geo-location data authentication engine application 250 to perform certain operations. The geo-location data authentication engine application 250 may be provided by the geo-location data authentication engine device 300. The one or more entity applications 270 may be any of the applications used, created, modified, facilitated, and/or managed by the entity system 200. The geo-location data authentication engine application 250 may be in communication with the geo-location data authentication engine device 300. In some embodiments, portions of the methods discussed herein may be carried out by the entity system 200.

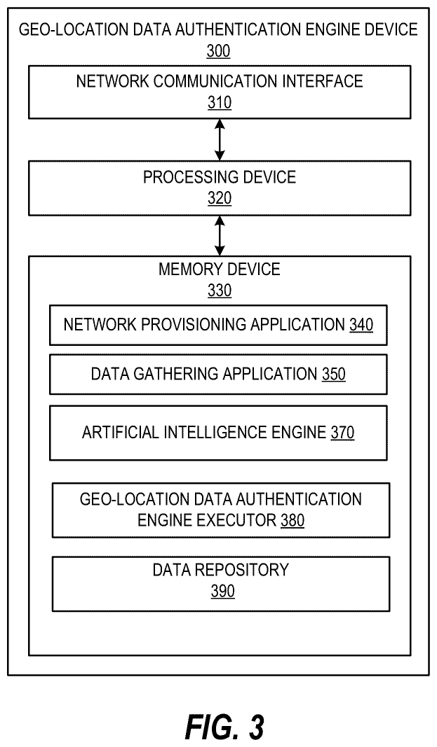

FIG. 3 provides a block diagram illustrating the geo-location data authentication engine device 300 in greater detail, in accordance with various embodiments). As illustrated in FIG. 3, in one embodiment, the geo-location data authentication engine device 300 includes one or more processing devices 320 operatively coupled to a network communication interface 310 and a memory device 330. In certain embodiments, the geo-location data authentication engine device 300 is operated by an entity, such as a financial institution. In some embodiments, the geo-location data authentication engine device 300 is owned or operated by the entity of the entity system 200. In some embodiments, the geo-location data authentication engine device 300 may be an independent system. In alternate embodiments, the geo-location data authentication engine device 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the geo-location data authentication engine device 300 described herein. For example, in one embodiment of the geo-location data authentication engine device 300, the memory device 330 includes, but is not limited to, a network provisioning application 340, a data gathering application 350, an artificial intelligence engine 370, a geo-location data authentication engine executor 380, and a data repository 390 comprising any data processed or accessed by one or more applications in the memory device 330. The computer-executable program code of the network provisioning application 340, the data gathering application 350, the artificial intelligence engine 370, and the geo-location data authentication engine executor 380 may instruct the processing device 320 to perform certain logic, data-processing, and data-storing functions of the geo-location data authentication engine device 300 described herein, as well as communication functions of the geo-location data authentication engine device 300.

The network provisioning application 340, the data gathering application 350, the artificial intelligence engine 370, and the geo-location data authentication engine executor 380 are configured to invoke or use the data in the data repository 390 when communicating through the network communication interface 310 with the entity system 200, and/or the computing device system 400. In some embodiments, the network provisioning application 340, the data gathering application 350, the artificial intelligence engine 370, and the geo-location data authentication engine executor 380 may store the data extracted or received from the entity system 200, and the computing device system 400 in the data repository 390. In some embodiments, the network provisioning application 340, the data gathering application 350, the artificial intelligence engine 370, and the geo-location data authentication engine executor 380 may be a part of a single application.

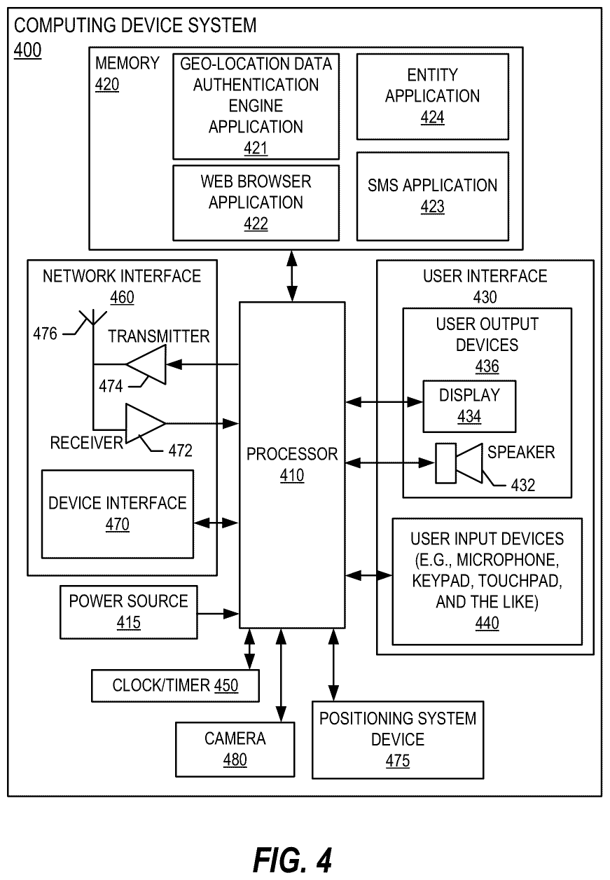

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, electronic media devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned. The computing device system 400 of various embodiments may be capable of rendering an API configuration.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the network 150. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include one or more displays 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a geo-location data authentication engine application 421, entity application 424. These applications also typically instructions to a graphical user interface (GUI) on the display 430 that allows the user 110 to interact with the entity system 200, the geo-location data authentication engine device 300, and/or other devices or systems. The memory 420 of the computing device system 400 may comprise a Short Message Service (SMS) application 423 configured to send, receive, and store data, information, communications, alerts, and the like via the network 150. In some embodiments, the geo-location data authentication engine application 421 provided by the geo-location data authentication engine device 300 allows the user 110 to access the geo-location data authentication engine device 300. In some embodiments, the entity application 424 provided by the entity system 200 and the geo-location data authentication engine application 421 allow the user 110 to access the functionalities provided by the geo-location data authentication engine device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

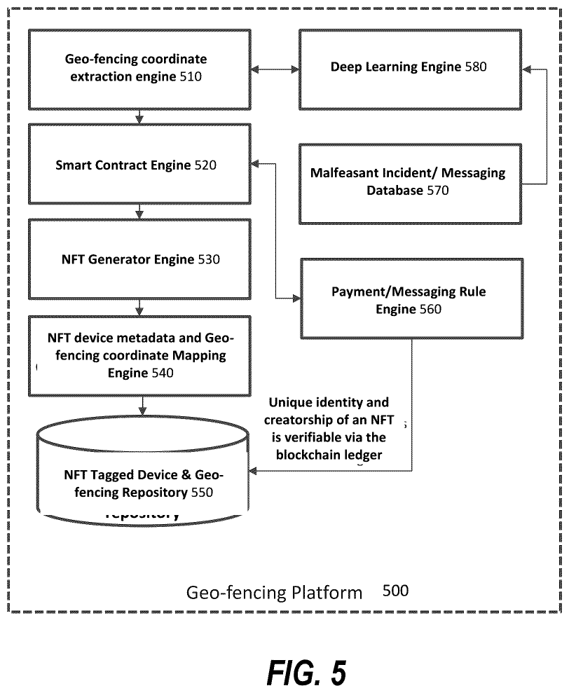

FIG. 5 illustrates an example geo-fencing platform for performing the method of preventing geo-location data tampering in accordance with an embodiment of the present disclosure. The geo-fencing platform 500 discussed in FIG. 5 may be the geo-location data authentication engine device 300 and/or the entity system 200. For example, each the various engines shown in the geo-fencing platform 500 may be a portion or sub-portion of the geo-location data authentication engine device 300 and/or the entity system 200 (e.g., using the processing and/or memory of either device).

The geo-fencing platform 500 may include a geo-fencing coordinate extraction engine 510, a smart contract engine 520, an NFT generator engine 530, an NFT device metadata and geo-coordinate mapping engine 540, a NFT tagged device and geo-fencing repository 550, a payment/messaging rule engine 560, a malfeasant incident/messaging database 570, and a deep learning engine 580. The methods discussed herein may use the malfeasant incident/messaging database 570 to generate geo-fencing coordinates that are linked to an associated instrument (e.g., a payment instrument). The geo-fencing coordinates are stored as a NFT (e.g., via the NFT generator engine 530) and is associated with the smart contract engine 520, which dictates pre-defined rules for the NFT. The generated NFT is stored and used for verifying geo-location data. The system also includes deep learning engine 580 (e.g., a machine learning model) that can be taught using data from the NFT as a training set.

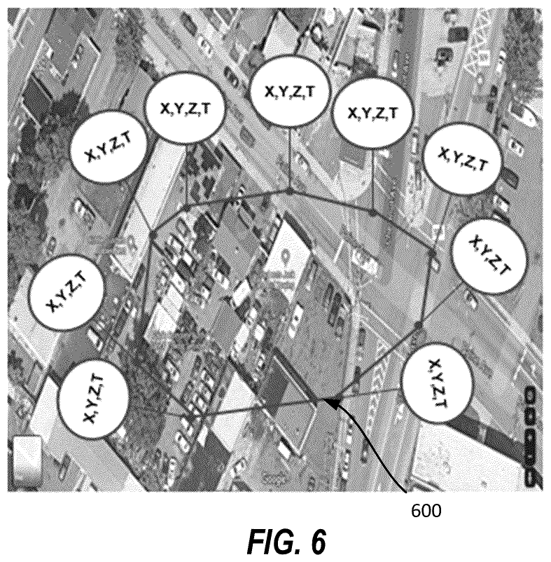

FIG. 6 illustrates an example geographic location that is being geo-fenced in accordance with an embodiment of the present disclosure. As shown, a geographic location may be geo-fenced with one or more coordinates that correspond to the location. As an example, the location of FIG. 6 is a location that is bound by nine coordinates. The coordinates may be in various forms (e.g., the x, y, z, t form shown). Various other embodiments may have more or less coordinates for a given location. The coordinates may be user provided or discerned from a location. For example, a user may input a given location and the coordinates may be generated. The coordinates may either separately or together be stored as one or more NFTs.

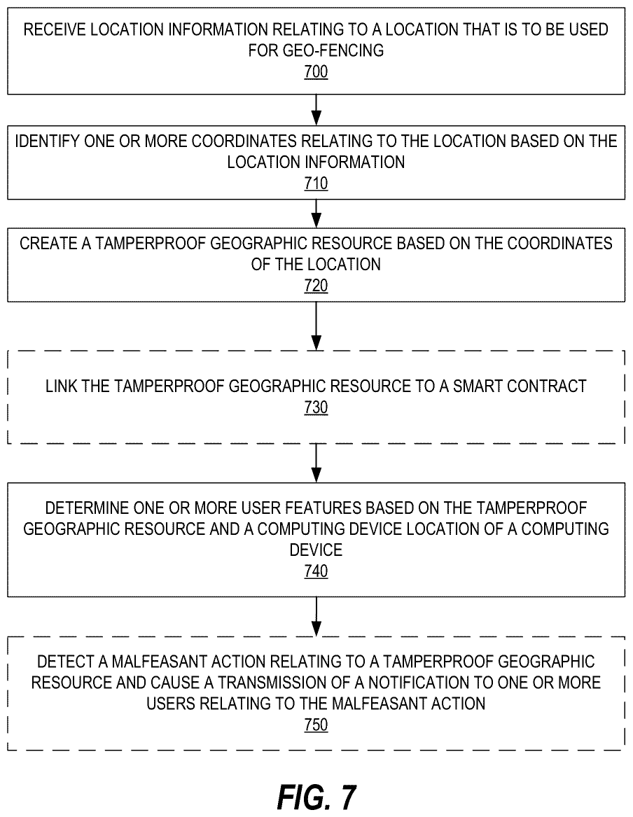

FIG. 7 illustrates another example method of preventing geo-location data tampering. The method may be carried out by a system discussed herein (e.g., the entity system 200, the geo-location data authentication engine device 300, the computing device system 400, and/or the geo-fencing platform 500). An example system may include at least one non-transitory storage device and at least one processing device coupled to the at least one non-transitory storage device. In such an embodiment, the at least one processing device is configured to carry out the method discussed herein.

Referring now to Block 700 of FIG. 7, the method includes receiving location information relating to a location that is to be used for geo-fencing. The location information may indicate a location for which geo-fencing is to be used. The location information may include one or more coordinates of the location. The one or more coordinates may be used to generate a geo-fence, such as the geo-fence 600 shown in FIG. 6. The one or more coordinates may be user inputted (e.g., via a computing device system 400 associated with the user 110). Alternatively, the coordinates may be automatically determined as discussed herein.

Additionally or alternatively, the location information may include non-coordinate information that can be used to determine the one or more coordinates of the location. Non-coordinate information may be any information that is used to determine the coordinates of a location, for example, a location address, a business name, device location information, and/or the like. Based on the non-coordinate information, the system is configured to identify one or more coordinates relating to the location based on the non-coordinate information. The identification of the one or more coordinates may be performed automatically upon receiving the location information.

Referring now to Block 710 of FIG. 7, the method includes identify one or more coordinates relating to the location based on the location information. In an instance in which the location information includes the one or more coordinates, the system may identify the one or more coordinates based on an analysis of the location information. In an instance in which the location does not specifically include the one or more coordinates, the system is configured to identify the one or more coordinates based on the non-coordinate information discussed above in reference to Block 700.

Referring now to Block 720 of FIG. 7, the method includes creating a tamperproof geographic resource based on the coordinates of the location. The system is configured to store the coordinates of the location as a non-fungible token (“location NFT”). The location NFT that is generated includes the coordinates of the location. Additionally, the location NFT may include metadata relating to one or more related devices. For example, the location NFT may include authorship information for the device that provided the location information and/or identified the one or more coordinates based on the location information. As such, the location NFT can be used for geo-fencing and also can be tracked to confirm authenticity (e.g., an entity can analyze the metadata to determine the creator of the location information). The location NFT may include various other metadata that relates to related devices and/or users (e.g., devices at a given location).

An NFT is a cryptographic record (referred to as “tokens”) linked to a resource. An NFT is typically stored on a distributed ledger that certifies ownership and authenticity of the resource, and exchangeable in a peer-to-peer network.

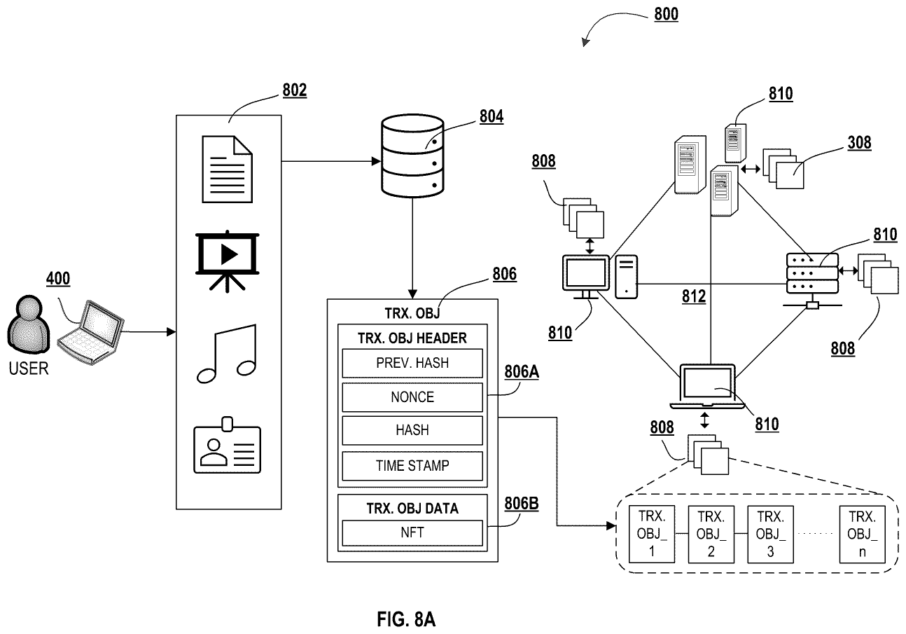

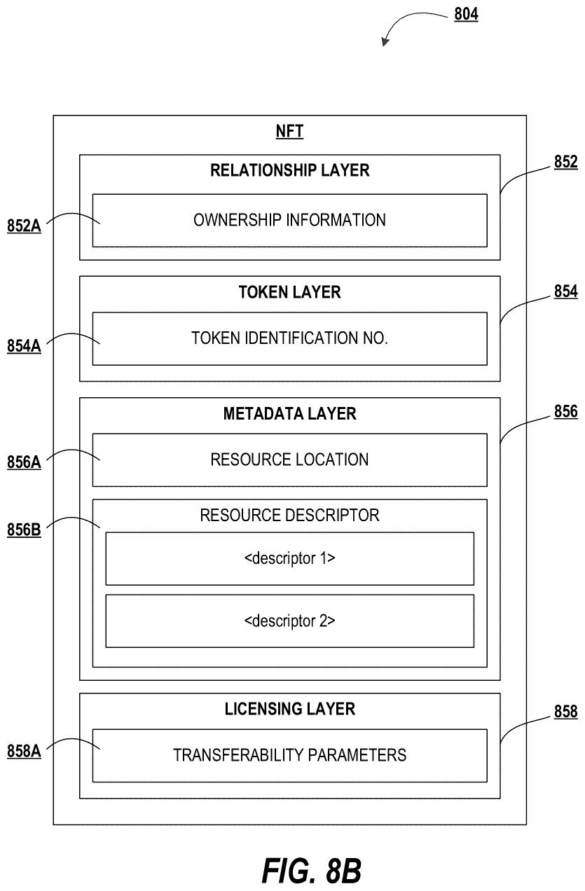

FIG. 8A illustrates an exemplary process of creating an NFT 800, in accordance with an embodiment of the present disclosure. As shown in FIG. 8A, to create or “mint” an NFT, a user (e.g., NFT owner) may identify, using a computing device system 400 associated with a user 110, resources 802 that the user wishes to mint as an NFT. Typically, NFTs are minted from digital objects that represent both tangible and intangible objects. These resources 802 may include a piece of art, music, collectible, virtual world items, videos, real-world items such as artwork and real estate, or any other presumed valuable object. These resources 802 are then digitized into a proper format to produce an NFT 804. The NFT 804 may be a multi-layered documentation that identifies the resources 802 but also evidences various transaction conditions associated therewith, as described in more detail with respect to FIG. 8A.

To record the NFT in a distributed ledger, a transaction object 806 for the NFT 804 is created. The transaction object 806 may include a transaction header 806A and a transaction object data 806B. The transaction header 806A may include a cryptographic hash of the previous transaction object, a nonce—a randomly generated 32-bit whole number when the transaction object is created, cryptographic hash of the current transaction object wedded to the nonce, and a time stamp. The transaction object data 806B may include the NFT 804 being recorded. Once the transaction object 806 is generated, the NFT 204 is considered signed and forever tied to its nonce and hash. The transaction object 806 is then deployed in the distributed ledger 808. At this time, a distributed ledger address is generated for the transaction object 806, i.e., an indication of where it is located on the distributed ledger 808 and captured for recording purposes. Once deployed, the NFT 804 is linked permanently to its hash and the distributed ledger 808, and is considered recorded in the distributed ledger 808, thus concluding the minting process

As shown in FIG. 8A, the distributed ledger 808 may be maintained on multiple devices (nodes) 810 that are authorized to keep track of the distributed ledger 808. For example, these nodes 810 may be computing devices such as entity system 200 and/or the geo-location data authentication engine device 300. One node 810 may have a complete or partial copy of the entire distributed ledger 808 or set of transactions and/or transaction objects on the distributed ledger 808. Transactions, such as the creation and recordation of a NFT, are initiated at a node and communicated to the various nodes. Any of the nodes can validate a transaction, record the transaction to its copy of the distributed ledger, and/or broadcast the transaction, its validation (in the form of a transaction object) and/or other data to other nodes.

FIG. 8B illustrates an exemplary NFT 804 as a multi-layered documentation of a resource, in accordance with an embodiment of the present disclosure. As shown in FIG. 8B, the NFT may include at least relationship layer 852, a token layer 854, a metadata layer 856, and a licensing layer 858. The relationship layer 852 may include ownership information 852A, including a map of various users that are associated with the resource and/or the NFT 804, and their relationship to one another. For example, if the NFT 804 is purchased by buyer B1 from a seller S1, the relationship between B1 and S1 as a buyer-seller is recorded in the relationship layer 852. In another example, if the NFT 804 is owned by O1 and the resource itself is stored in a storage facility by storage provider SP1, then the relationship between O1 and SP1 as owner-file storage provider is recorded in the relationship layer 852. The token layer 854 may include a token identification number 854A that is used to identify the NFT 804. The metadata layer 856 may include at least a file location 856A and a file descriptor 856B. The file location 856A may provide information associated with the specific location of the resource 802. Depending on the conditions listed in the smart contract underlying the distributed ledger 808, the resource 802 may be stored on-chain, i.e., directly on the distributed ledger 808 along with the NFT 804, or off-chain, i.e., in an external storage location. The file location 856A identifies where the resource 802 is stored. The file descriptor 856B may include specific information associated with the source itself 802. For example, the file descriptor 856B may include information about the supply, authenticity, lineage, provenance of the resource 802. The licensing layer 858 may include any transferability parameters 858B associated with the NFT 804, such as restrictions and licensing rules associated with purchase, sale, and any other types of transfer of the resource 802 and/or the NFT 804 from one person to another. Those skilled in the art will appreciate that various additional layers and combinations of layers can be configured as needed without departing from the scope and spirit of the present disclosure.

Referring now to optional Block 730 of FIG. 7, the method includes linking the tamperproof geographic resource to a smart contract. The smart contract may include pre-defined rules for geo-fencing that can link to the tamperproof geographic resource (e.g., link to the location NFT). The smart contract may include the user features based on the geo-fencing. For example, the smart contract may contain the level of access for a user, authentication allowances for devices, whether to send notifications to users within the geo-fencing, and/or the like. The smart contract may be the same or similar across multiple geo-locations. For example, a bank may have the same user features at each branch location.

The pre-defined rules may be determined based on a previous malfeasance. For example, a point of sale device at a merchant location may have been hacked and the smart contract may indicate that a transaction amount should be reduced within a certain range of the point of sale device. In such an example, the system may dynamically create the location NFT without user input of the location information (e.g., the location information may be received indicating a malfeasant action relating to a point of sale device and the system may then determine the one or more coordinates based on the location of the point of sale device).

Referring now to Block 740 of FIG. 7, the method includes determining one or more user features based on the tamperproof geographic resource and a computing device location of a computing device. The one or more user features can determine the capabilities of the computing device. The user feature(s) may include permissions, authorizations, restrictions, and/or the to the capabilities of a user. For example, transactions of a user may be limited in a given area based on a malfeasant action. In another example, a user may input a restricted area in which the user does not want to allow transactions (e.g., restricting making a purchase at a given location) and therefore the system is configured to restrict user features within the given location. The user features may also include a reduction in purchasing power (e.g., limiting a transaction amount to a limit), limiting or allowing network capabilities (e.g., certain features may not be allowed within certain locations and are therefore restricted).

Various embodiments of the present disclosure allow for the geo-location data that is used for geo-fencing to be protected from malfeasant or inadvertent modifications to the geo-location data. Since the geo-location data is stored as a location NFT, the geo-location data includes ownership information that allows for the geo-location data to be authenticated.

Referring now to optional Block 750 of FIG. 7, the method includes detecting a malfeasant action relating to a tamperproof geographic resource and cause a transmission of a notification to one or more users relating to the malfeasant action. The tamperproof geographic resource may be generated based on the malfeasant action. For example, a merchant point of sale device may be hacked, and the tamperproof geographic resource may include the coordinates of an area around the hacked device. One or more remedial actions may be carried out on devices within the geo-fence coordinates of the hacked device. For example, devices within the geo-fence coordinates receive a notification of a potential malfeasance. Additionally or alternatively, the capabilities of users within the geo-fence coordinates may be restricted. For example, transaction amounts may be limited for device within the geo-fence coordinates or transactions may be rejected altogether.

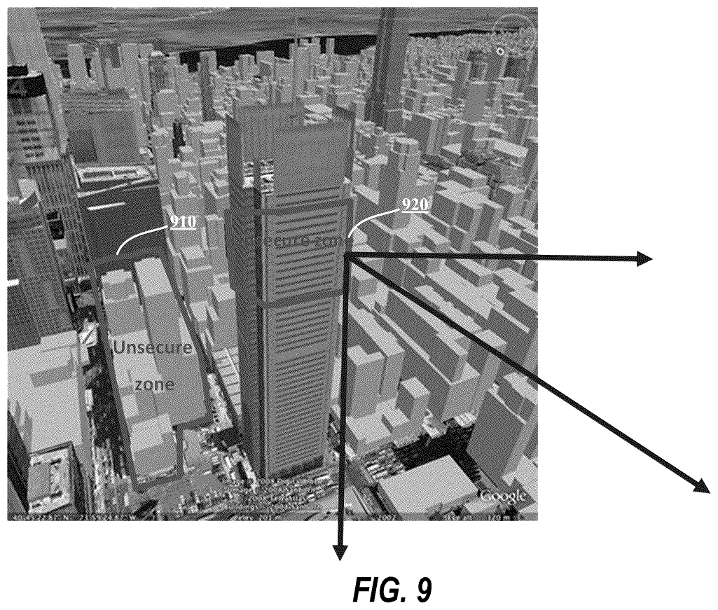

FIG. 9 illustrates another example use case of geo-fencing that may use various embodiments of the present disclosure. As shown, the unsecured areas 910, 920 may each be geo-fenced areas that are stored as location NFTs. Each of the unsecured areas 910, 920 may be an individual location NFT. As shown, unsecured area 920 is a portion of a multi-story building, such that the unsecured area 920 is only for specific floors of the multiple story building. For example, a company may only allow access to the company network in an instance in which an employee is on a given floor. Therefore, the geo-fence coordinates may be three dimensional. Alternatively, the geo-fence coordinates may only be two dimensional and may not account for height.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

What is claimed is:

1. A system for preventing geo-location data tampering, the system comprising:
at least one non-transitory storage device; and
at least one processing device coupled to the at least one non-transitory storage device, wherein the at least one processing device is configured to:
receive location information relating to a location that is to be used for geo-fencing;
identify one or more coordinates relating to the location based on the location information;
create a tamperproof geographic resource based on the coordinates of the location, wherein the tamperproof geographic resource is stored as a non-fungible token; and
based on the tamperproof geographic resource and a computing device location of a computing device, determine one or more user features, wherein the one or more user features determine the capabilities of the computing device.

2. The system of claim 1, wherein the tamperproof geographic resource includes one or more instrument indicators, wherein the one or more instrument indicators include information relating to an instrument that transmitted the one or more coordinates relating to the location.

3. The system of claim 1, wherein the location information comprises the one or more coordinates relating to the location, wherein the location information is received from a computing device associated with a user.

4. The system of claim 1, wherein the location information comprises non-coordinate information that relates to the location, wherein the at least one processing device is further configured to automatically identify the coordinates relating to the location based on the location information.

5. The system of claim 1, wherein the tamperproof geographic resource comprises information relating to an author of the tamperproof geographic resource.

6. The system of claim 1, wherein the at least one processing device is further configured to detect a malfeasant action relating to a tamperproof geographic resource and cause a transmission of a notification to one or more users relating to the malfeasant action.

7. The system of claim 1, wherein the at least one processing device is further configured to link the tamperproof geographic resource to a smart contract, wherein the smart contract includes one or more location rules relating to the location.

8. A computer program product for preventing geo-location data tampering, the computer program product comprising at least one non-transitory computer-readable medium having computer-readable program code portions embodied therein, the computer-readable program code portions comprising:
an executable portion configured to receive location information relating to a location that is to be used for geo-fencing;
an executable portion configured to identify one or more coordinates relating to the location based on the location information;
an executable portion configured to create a tamperproof geographic resource based on the coordinates of the location, wherein the tamperproof geographic resource is stored as a non-fungible token; and
an executable portion configured to determine one or more user features based on the tamperproof geographic resource and a computing device location of a computing device, wherein the one or more user features determine the capabilities of the computing device.

9. The computer program product of claim 8, wherein the tamperproof geographic resource includes one or more instrument indicators, wherein the one or more instrument indicators include information relating to an instrument that transmitted the one or more coordinates relating to the location.

10. The computer program product of claim 8, wherein the location information comprises the one or more coordinates relating to the location, wherein the location information is received from a computing device associated with a user.

11. The computer program product of claim 8, wherein the location information comprises non-coordinate information that relates to the location, wherein the computer program product further comprises an executable portion configured to automatically identify the coordinates relating to the location based on the location information.

12. The computer program product of claim 8, wherein the tamperproof geographic resource comprises information relating to an author of the tamperproof geographic resource.

13. The computer program product of claim 8, further comprising an executable portion configured to detect a malfeasant action relating to a tamperproof geographic resource and cause a transmission of a notification to one or more users relating to the malfeasant action.

14. The computer program product of claim 8, further comprising an executable portion configured to link the tamperproof geographic resource to a smart contract, wherein the smart contract includes one or more location rules relating to the location.

15. A computer-implemented method for preventing geo-location data tampering, the method comprising:
receiving location information relating to a location that is to be used for geo-fencing;
identifying one or more coordinates relating to the location based on the location information;
creating a tamperproof geographic resource based on the coordinates of the location, wherein the tamperproof geographic resource is stored as a non-fungible token; and
based on the tamperproof geographic resource and a computing device location of a computing device, determining one or more user features, wherein the one or more user features determine the capabilities of the computing device.

16. The method of claim 15, wherein the tamperproof geographic resource includes one or more instrument indicators, wherein the one or more instrument indicators include information relating to an instrument that transmitted the one or more coordinates relating to the location.

17. The method of claim 15, wherein the location information comprises the one or more coordinates relating to the location, wherein the location information is received from a computing device associated with a user.

18. The method of claim 15, wherein the location information comprises non-coordinate information that relates to the location, wherein the method further comprises automatically identifying the coordinates relating to the location based on the location information.

19. The method of claim 15, further comprising detecting a malfeasant action relating to a tamperproof geographic resource and cause a transmission of a notification to one or more users relating to the malfeasant action.

20. The method of claim 15, further comprising linking the tamperproof geographic resource to a smart contract, wherein the smart contract includes one or more location rules relating to the location.
